(19) United States
(12) Patent Application Publication
(10) Pub. No.: US 2026/0211106 A1
(43) Pub. Date: Jul. 23, 2026

(54) A METHOD FOR COMPUTER-IMPLEMENTED PROCESSING OF SAR RAW DATA

(71) Applicants: DEUTSCHES ZENTRUM FÜR LUFT- UND RAUMFAHRT E.V., Bonn (DE); FRIEDRICH-ALEXANDER-UNIVERSITÄT ERLANGEN-NÜRNBERG, Erlangen (DE)

(72) Inventors: Andreas BENEDIKTER, München (DE); Marc RODRIGUEZ-CASSOLA, München (DE); Gerhard KRIEGER, Gauting (DE); Alberto MOREIRA, Olching (DE); Martin VOSSIEK, Fürth (DE)

(21) Appl. No.: 19/140,750

(22) PCT Filed: Dec. 13, 2023
(86) PCT No.: PCT/EP2023/085532

§ 371 Date: Jun. 18, 2025

(30) Foreign Application Priority Data
Dec. 19, 2022 (DE) 10 2022 133 858.4

(51) Int. Cl. G01S 13/90

(52) U.S. Cl. CPC G01S 13/9021; G01S 13/9011; G01S 13/9041

(57) ABSTRACT

The invention relates to a method for computer-implemented processing of SAR raw data (RD) which originate from a radar equipment flying over the earth's surface (GR) in an azimuth direction (x), wherein the SAR raw data (RD) represent radar echoes of radar pulses (RP) during a single overflight of an area of the earth's surface (GR), where the radar pulses (RP) are or were transmitted by the radar equipment and the radar echoes are or were received by the radar equipment as radar pulses reflected at the earth's surface (GR), wherein
a) a first frequency range (FB1) of the Doppler spectrum (DS) with a first Doppler center frequency (f_{DC1}) and a second frequency range (FB2) of the Doppler spectrum (DS) with a second Doppler center frequency (f_{DC2}) are extracted from the SAR raw data (RD);
b) a first SAR image (IM1) is determined from the first frequency range (FB1) and a second SAR image (IM2) is determined from the second frequency range (FB2);
c) for a respective image area (IA) of a number of image areas (IA) in the first SAR image (IM1), a displacement value (Δx) is determined which indicates by how much the image content in the respective image area (IA) from the first SAR image (IM1) is displaced in azimuth direction (x) relative to the same image content in a corresponding image area (IA) from the second SAR image (IM2), wherein the respective image area (IA) and the corresponding image area (IA) represent the same surface area with respect to the azimuth direction (x) and the range direction (R);
d) a snow depth (Zₛ) in the respective image area (IA) is determined from the displacement value (Δx).

### FIELD OF THE INVENTION

The present invention relates to a method for computer-implemented processing of SAR raw data.

In order to determine water resources on the earth's surface and to analyze the effects of climate change, the snow depth and snow density on the earth's surface and the associated snow water equivalent are important quantities. The snow water equivalent is defined as the height of the water column that would be obtained if all the ice in a corresponding layer of snow were to melt. Specifically, the snow water equivalent is given by the following equation:

$$SWE = \frac{1}{{ρ}_{w}} \cdot {\int }_{0}^{{Z}_{s}} {ρ}_{s} ( z ) d z \qquad ( 1 )$$

where SWE is the snow water equivalent, Zₛ is the snow depth, z is the vertical coordinate (coordinate in height direction) and ρ_{w} is the volumetric mass density of water. Furthermore, ρₛ(z) denotes the snow density (i.e. the volumetric mass density of snow), which depends on the vertical coordinate z.

To determine the snow water equivalent locally, pressure sensors, acoustic sensors or gamma radiation sensors can be used, which are positioned at the location where the snow water equivalent is to be measured. However, this means that the snow water equivalent can only be determined at specific positions on the earth's surface.

There are also prior art methods that use remote sensing via passive microwave sensors on satellites to determine snow depths on the earth's surface. However, these methods have poor spatial resolution in the kilometer range and low accuracy.

There are also experimental methods in the prior art that use SAR systems to determine snow depths or corresponding snow water equivalents on the earth's surface. SAR systems (SAR=synthetic aperture radar) enable remote sensing of the earth's surface by detecting radar pulses reflected from the earth's surface, which are transmitted by radar equipment moving at a constant speed above the earth's surface in a so-called azimuth direction. With suitable processing, images of the earth's surface can be obtained from the SAR raw data captured by a SAR system.

To determine snow depths with SAR systems, differential SAR interferometry is currently used, which is described, for example, in the document [1]. Here, changes in snow depth or snow water equivalent are determined by measuring a differential signal delay between two temporally separated SAR acquisitions from the same area of the earth's surface. The signal delay is caused by the refraction at the snow surface and the reduced propagation speed of the radar radiation in snow and depends on the snow depth and snow density. A snow accumulation between two SAR acquisitions leads to a differential signal delay, from which the change in snow depth in the period between the two acquisitions can be determined.

Known SAR methods for determining snow depth have the disadvantage that only differences in snow depth can be detected and that multiple overflights over the same area of the earth's surface are required for this. This can lead to temporal decorrelation effects due to the change in the distribution of the backscatterers in the recorded area of the earth's surface. In addition, differential SAR interferometry uses phase measurements that lead to a so-called 2π phase ambiguity and thus make it difficult to convert the phase measurements into a snow depth or the snow water equivalent.

### SUMMARY

The object of the invention is to provide a method for computer-implemented processing of SAR raw data, with which the snow depth of the area of the earth's surface captured by the raw data can be determined in a simple manner from the SAR raw data.

This object is solved by the method according to patent claim 1 or the device according to patent claim 8. Further embodiments of the invention are defined in the dependent claims.

The method according to the invention is used to process SAR raw data originating from a radar equipment flying over the earth's surface in an azimuth direction. The SAR raw data represent radar echoes from radar pulses during a single overflight over an area of the earth's surface. The radar pulses are or were transmitted by the radar equipment and the radar echoes are or were received by the radar equipment as radar pulses reflected on the earth's surface. The transmission and reception of the radar pulses and, in this sense, the acquisition of the SAR raw data can be part of the method according to the invention. Similarly, the acquisition of the SAR raw data may not be part of the method according to the invention, i.e. the method accesses SAR raw data that has already been acquired. In one embodiment, the SAR raw data are already processed in the radar equipment or at the location of the radar equipment using the method according to the invention. Typically, however, the SAR raw data are transmitted to a ground station on the earth's surface, where the SAR raw data is then processed according to the invention.

In a manner known per se, the SAR raw data processed according to the invention comprise a plurality of data samples containing a Doppler spectrum. The Doppler spectrum results from the fact that the radar equipment moves during the acquisition of the SAR raw data and this results in a phase variation of the acquired radar echoes. A respective data sample in the SAR raw data belongs to an azimuth position along the azimuth direction and a range position along a range direction, with the range direction running perpendicular to the azimuth direction.

In the method according to the invention, in a step a), a first frequency range of the Doppler spectrum with a first Doppler center frequency and a second frequency range of the Doppler spectrum with a second Doppler center frequency are extracted from the SAR raw data, wherein the first frequency range and the second frequency range of the Doppler spectrum are disjoint, i.e. the frequencies of the two frequency ranges do not overlap and their Doppler center frequencies differ. Step a) can be carried out using methods known per se by applying corresponding frequency filters in the frequency range of the SAR raw data.

In a step b) of the method according to the invention, a first SAR image is determined from the first frequency range with a SAR processing known per se. In the same way, in step b), a second SAR image is determined from the second frequency range using a SAR processing known per se. During the SAR processing, the correspondingly focused SAR images are generated by means of a so-called range compression and a so-called azimuth compression.

In a step c) of the method according to the invention, a displacement value is determined for a respective image area of a number of image areas in the first SAR image, the displacement value indicating by how much the image content in the respective image area from the first SAR image is displaced in the azimuth direction with respect to the same image content in a corresponding image area from the second SAR image. The respective image area in the first SAR image and the corresponding image area in the second SAR image represent the same area with respect to the azimuth direction and the range direction, i.e. the image areas have the same coordinates in the azimuth and range directions and also the same extent along these coordinates. Preferably, the first SAR image and correspondingly also the second SAR image is divided into a plurality of image areas where for each image area a displacement value is determined. Nevertheless, the first SAR image and the second SAR image each can also represent one image area in total.

Finally, the displacement value determined in step c) is used to determine a snow depth in the respective image area. The term displacement value is to be understood broadly. It a quantity that represents an offset in the azimuth direction in corresponding SAR images. This quantity can be specified by a distance on the earth's surface, but possibly also by a time offset (azimuth time) corresponding to the movement of the radar equipment, or a phase value.

The method according to the invention is based on the finding that an azimuth shift of the image contents in SAR images recorded for different frequency ranges in the Doppler spectrum has a direct correlation to the snow depth. In the detailed description, the relationship between this azimuth shift and the snow depth recognized by the inventors is explained in more detail.

The method according to the invention has the great advantage that the absolute snow depth can be determined in a single overflight over the earth's surface. As a result, temporal decorrelation effects do not play a role. The method thus avoids the disadvantages of differential SAR interferometry, in which only changes in snow depth can be determined and for this purpose the corresponding area on the earth's surface must be flown over several times. In addition, the method according to the invention can achieve a good spatial resolution in the range of 100 m or less for the determination of corresponding snow depths.

The snow depth determined using the method according to the invention can be stored for later evaluation and, if necessary, output via a user interface. Furthermore, the snow depth can also be used to determine a value dependent on the snow depth, which in turn can be stored for later evaluation and, if necessary, can be output via a user interface. In a preferred embodiment, the snow water equivalent is determined as the value dependent on the snow depth. The snow water equivalent is a frequently used quantity to determine water resources on the earth's surface or to analyze effects of climate change. As explained above, the snow water equivalent is defined as the water level that would exist if all the ice within a snow cover were to melt.

In a particularly preferred embodiment, the snow depth is determined in step d) as follows:

$${Z}_{s} = \frac{\sqrt{{ε}_{s}} \cdot ( h - h \cdot ζ )}{\frac{cos {θ}_{i}}{cos {θ}_{r}} \cdot ( ζ - {ε}_{s} )}$$

wherein Zₛ is the snow depth;
wherein εₛ is the real part of the relative dielectric permittivity of snow;
wherein h the flight altitude of the radar equipment above the snow surface;
wherein θᵢ is the incidence angle of the radar pulses in the respective image area;
wherein θᵣ is the refraction angle of the radar pulses in the respective image area on the snow surface;
wherein

$$ζ = \frac{Δ x \cdot {f}_{R , a}}{( {f}_{D C 2} - {f}_{DC 1} ) \cdot {v}_{e}} + 1$$

wherein Δx is the displacement value in meters in the azimuth direction;
wherein vₑ is the azimuth speed of the radar equipment;
wherein f_{DC1} is the first Doppler center frequency;
wherein f_{DC2} is the second Doppler center frequency;
wherein f_{R,α} is the Doppler rate without snow in the respective image area.

A derivation of the above equations can be found in the detailed description. As can be seen from the equations above, the snow depth Zₛ is dependent on the displacement value Δx via the quantity ζ.

In addition to the displacement value, which is determined in step c) of the method according to the invention, all other quantities contained in the above formulae are already known or can be determined appropriately. For example, the refraction angle can be determined from the incidence angle of the radar radiation in the corresponding image area using Snellius' law of refraction (see equation (2) in the detailed description). Similarly, the Doppler rate can be determined from known quantities (see equation (5) in the detailed description).

The method according to the invention can be applied to SAR raw data from current space missions. Preferably, however, a special radar equipment is used in the acquisition of the SAR raw data, which enables an efficient separation of the SAR raw data into two separate Doppler frequency ranges and generates a large separation of the two Doppler frequency ranges. The SAR raw data originate from a radar equipment comprising an antenna equipment which generates an antenna beam for transmitting and receiving radar radiation in a first beam direction and an antenna beam for transmitting and receiving radar radiation in a second beam direction (simultaneously), wherein the first beam direction is inclined at a first inclination angle relative to the plane perpendicular to the azimuth direction and the second beam direction is inclined at a second inclination angle relative to the plane perpendicular to the azimuth direction, the first beam direction and the second beam direction being different from each other. With this setup, dedicated SAR raw data are acquired in two separate Doppler frequency ranges over different inclination angles. These inclination angles are also referred to as squint angles. The first beam direction described above and the second beam direction described above each preferably represent a main beam direction of the antenna equipment, wherein the main beam direction is the direction in which the greatest power is emitted within the corresponding antenna beam.

In a particularly preferred embodiment, the first inclination angle is a backward angle, so that the first beam direction lies behind the radar equipment with respect to the movement of the radar equipment in the azimuth direction. In contrast, the second inclination angle is a forward angle, so that the second beam direction is in front of the radar equipment with respect to the movement of the radar equipment in the azimuth direction. In other words, the antenna beam in the first beam direction illuminates an area on the earth's surface that lies behind the radar equipment in the direction of flight of the radar equipment, whereas the antenna beam in the second beam direction illuminates an area on the earth's surface that lies in front of the radar equipment in the direction of flight of the radar equipment.

In a further preferred embodiment, the forward angle is between 2° and 40°, preferably between 5° and 25° and particularly preferably between 15° and 25°. Similarly, the backward angle can be between 2° and 40°, preferably between 5° and 25° and particularly preferably between 15° and 25°. The angular degrees mentioned refer to the smallest included angle between the first or second beam direction and the plane perpendicular to the azimuth direction. The aforementioned angular ranges enable an efficient separation of the SAR raw data into two frequency ranges with different Doppler center frequencies and a large distance between the two frequency ranges and thus an accurate determination of the above displacement value or the snow depth determined therefrom.

In a further preferred embodiment, the forward angle is the same as the backward angle, which simplifies the processing of the SAR raw data.

Besides the method described above, the invention relates to an apparatus for computer-implemented processing of SAR raw data originating from a radar equipment flying over the earth's surface in an azimuth direction, the SAR raw data representing radar echoes from radar pulses during a single overflight over an area of the earth's surface, wherein the radar pulses are or were transmitted by the radar equipment and the radar echoes are or were received as radar pulses reflected at the earth's surface by the radar equipment, wherein the SAR raw data comprise a plurality of data samples containing a Doppler spectrum, wherein a respective data sample is associated with an azimuth position along the azimuth direction and a range position along a range direction, wherein the range direction is perpendicular to the azimuth direction.

The apparatus according to the invention is adapted to carry out the method according to the invention. In other words, the apparatus comprises a signal processing device with which steps a) to d) of the method of claim 1 can be carried out. In a particularly preferred embodiment, the apparatus according to the invention is configured to carry out one or more preferred variants of the method according to the invention. Depending on the embodiment, the radar equipment described above may be part of the apparatus according to the invention, or the apparatus according to the invention may only include the signal processing device for carrying out steps a) to d). The signal processing device may be provided on the platform on which the radar equipment is located. Preferably, however, the signal processing device is provided on the earth's surface, e.g. in a ground station where the SAR raw data transmitted to the earth are evaluated.

The invention further relates to a computer program product comprising a program code stored on a machine-readable storage medium for carrying out the method according to the invention or one or more preferred variants of the method according to the invention, when the program code is executed on a computer.

Furthermore, the invention relates to a computer program comprising a program code for carrying out the method according to the invention or one or more preferred variants of the method according to the invention when the program code is executed on a computer.

### BRIEF DESCRIPTION OF THE DRAWINGS

Embodiments of the invention are described in detail below with reference to the accompanying figures, wherein

FIG. 1 is a schematic illustration showing the SAR principle used in the invention;

FIG. 2 and FIG. 3 are schematic illustrations showing the effects of a layer of snow on the acquisition of SAR raw data;

FIG. 4 is a schematic illustration showing the acquisition of SAR raw data according to one embodiment of the invention;

FIG. 5 is a diagram showing the steps of one embodiment of the method according to the invention; and

FIG. 6 to FIG. 10 are diagrams which illustrate the results of one embodiment of the method according to the invention using a simulation.

### DETAILED DESCRIPTION

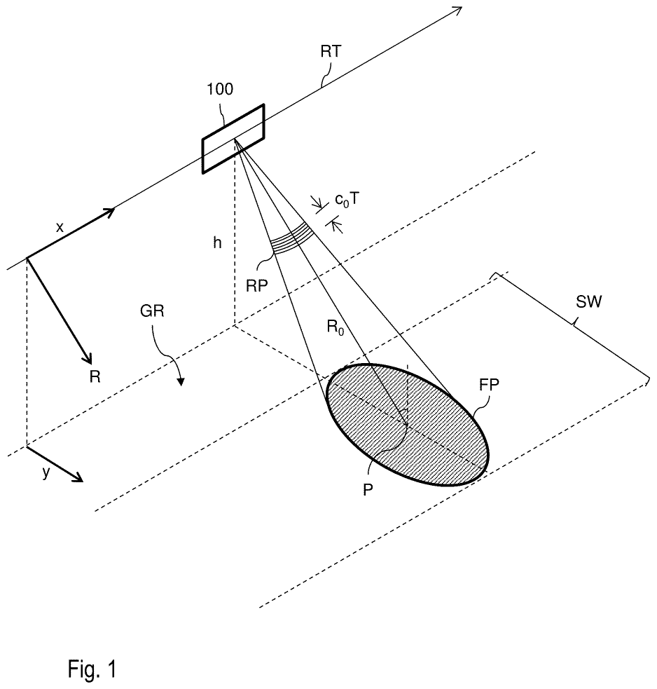

FIG. 1 shows a schematic illustration of a SAR radar equipment 100, which is indicated as a rectangular aperture and comprises one or more antennas or one or more antenna main radiation directions, depending on the embodiment. In the illustrated scenario, the radar equipment is located on a satellite (not shown), which moves at altitude h along the radar track RT above the earth's surface GR. The direction of the radar track corresponds to the azimuth direction known per se, which is denoted by reference sign x in FIG. 1. Instead of moving the radar equipment by means of a satellite, it may also be possible to use another flying object, such as an aircraft.

The radar equipment 100 emits radar pulses RP in successive pulse repetition intervals with a predetermined pulse repetition frequency in an oblique direction onto the earth's surface GR. Most of the energy of a respective radar pulse is directed towards the elliptical area FP on the earth's surface. This area is usually referred to as “footprint” of the radar equipment or the associated radar antenna.

According to FIG. 1, a respective radar pulse RP has a predetermined pulse duration T, so that the radar pulse has the spatial extent c₀T, where c₀ corresponds to the speed of light. As part of a SAR measurement, radar echoes of the radar pulse RP scattered back from the earth's surface are received and recorded by the SAR radar equipment 100 during their movement along the path RT. In this way, information about the earth's surface is detected in the swath SW. The radar equipment is configured that it is set up both to transmit radar pulses and to receive corresponding radar echoes. The radar echoes detected by the radar equipment depend on the shape and nature of the earth's surface and, with known downstream signal processing, enable SAR images of the earth's surface to be calculated.

Before downstream signal processing, the detected radar echoes are available as so-called SAR raw data after an analog-to-digital conversion. These raw data are data samples that contain the amplitude and phase of the sampled radar echoes. The raw data are arranged in a two-dimensional matrix, where one dimension of the matrix corresponds to the respective transmitted radar pulse (represented by a pulse number) and the other dimension of the matrix represents a time delay, which represents the time it takes for a sampled radar echo to propagate from the radar equipment to the earth's surface and back to the radar equipment 100. In other words, this time duration represents the so-called slant range R, which corresponds to the distance between the radar equipment and the scattering point of the radar echo on the earth's surface. This distance can therefore be equated with the direction from which the sampled radar echo travels from the earth's surface GR to the radar equipment 1.

In the scenario shown in FIG. 1, the reflection of a radar echo at the scattering point P on the earth's surface is shown as an example. The slant range of this radar echo is labeled R₀. The slant range is geometrically related to the so-called ground range, which is labeled y in FIG. 1 and represents the distance between the vertical projection of the radar track RT onto the earth's surface and the corresponding scattering point. The value of a slant range R can therefore be uniquely converted into the value of a corresponding ground range y.

As already mentioned, the SAR raw data are subjected to downstream signal processing, also known as SAR processing. Depending on the embodiment, this signal processing can already take place in the satellite, with the processed information then being sent to a ground station on the earth's surface. It is also possible for the SAR raw data to be sent to a ground station without post-processing, with post-processing being carried out at the ground station in order to obtain corresponding SAR images from the raw data. The post-processing comprises two filter operations, which are carried out along the range direction R or y and along the azimuth direction x. The filter operation along the range direction is often referred to as range compression and the filter operation along the azimuth direction as azimuth compression. These operations are used to focus the SAR raw data in order to calculate SAR images.

When acquiring SAR raw data, the radar equipment 100 moves along the azimuth direction x, so that the corresponding point P on the earth's surface is detected several times from different positions relative to the radar equipment 100. Depending on the relative position, the phase of the backscattered radar pulses varies, which corresponds to the well-known Doppler effect. The change in phase as a function of the azimuth position of the radar equipment 100 relative to the scattering point P is the Doppler frequency known per se. The SAR raw data thus contain a Doppler spectrum of Doppler frequencies in the frequency domain.

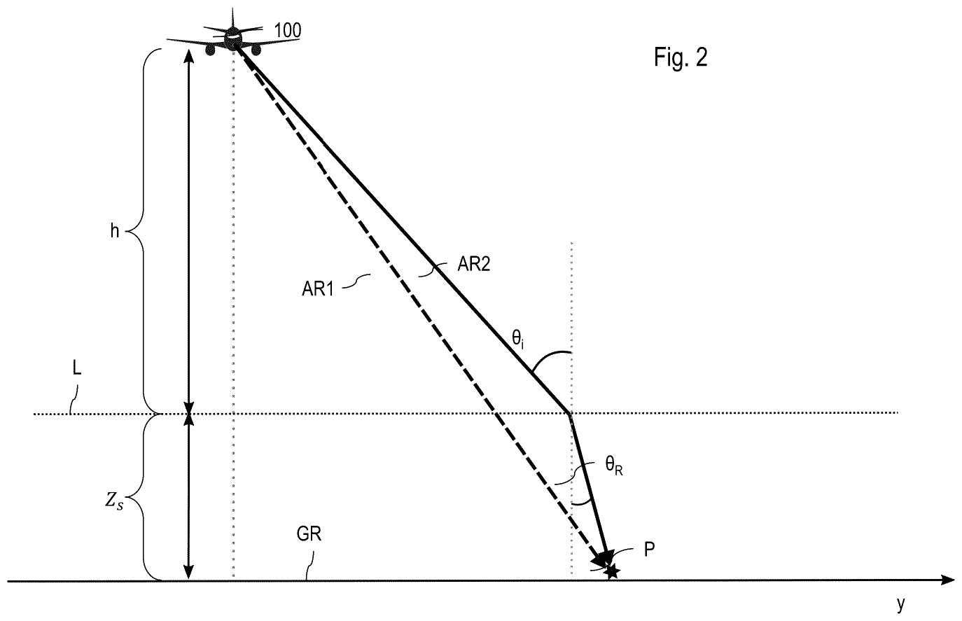

In the embodiment of the invention described here, the SAR raw data are processed in such a way that the snow depth or the snow water equivalent for the earth's surface recorded by the SAR radar equipment can be determined directly in a single overflight. Before discussing an embodiment of the invention in detail, FIG. 2 is used to explain how the radar radiation transmitted by a SAR radar equipment is changed by snow on the earth's surface.

FIG. 2 shows the signal propagation of the radar radiation transmitted by a SAR radar equipment 100 installed in a flying object, looking towards the oncoming flying object (i.e. looking in the opposite direction to the azimuth direction x in FIG. 1). On the earth's surface GR there is snow with a snow depth Zₛ, whereby the surface of the snow is indicated by a dotted line L. The flight altitude of the radar equipment above the snow surface is denoted by h in FIG. 2.

The dashed arrow AR1 in FIG. 2 illustrates the propagation path of a radar beam to a point P on the earth's surface when there is no snow. In contrast, the solid arrow AR2 illustrates the propagation path in the presence of snow with the snow depth Zₛ. The radar radiation partially passes through the snow and interacts with the snow through absorption, scattering, refraction and a reduced propagation speed. For a layer of snow a few meters deep, absorption and scattering effects are negligible compared to the backscattered energy from the underlying earth's surface GR. In contrast, the effect of refraction and reduced propagation speed of radar radiation is not negligible. The refraction leads to a deflection of the radar radiation falling on the snow at the snow surface L. According to FIG. 2, the incidence angle of the radar radiation on the snow surface is labeled θᵢ, whereas the reflection angle or refraction angle of the radar radiation, which is reduced by refraction, is labeled θᵣ. The refraction of the radar radiation is caused by the difference in dielectric permittivity between air and snow. Refraction is described in a well-known manner by Snellius' law of refraction, which reads as follows:

$$\sqrt{{ε}_{a}} \cdot sin {θ}_{i} = \sqrt{{ε}_{s}} \cdot sin {θ}_{r} \qquad ( 2 )$$

Here, εₐ and εₛ denotes the real part of the relative dielectric permittivity of air and snow, respectively. The permittivity εₐ of air is approximately 1. The propagation speed c of radar radiation in snow is reduced compared to the speed of light cₒ in air and is as follows.

$$c = \frac{{c}_{o}}{\sqrt{{ε}_{s}}} \qquad ( 3 )$$

The real part of the relative permittivity εₛ of snow is a function of the snow density ρₛ.

In the embodiment of the invention described below, the additional phase delay of the backscattered radar radiation caused by the snow layer, which has an effect on the Doppler frequency and Doppler rate (i.e. the temporal change or derivative of the Doppler frequency), is utilized to obtain the snow depth of the snow layer or the snow water equivalent.

In conventional SAR processing of SAR raw data, it is assumed that only air is present as the propagation medium, without taking into account the effects of a snow cover. This leads to a phase error along the azimuth direction between the recorded SAR signal and the signal after filtering during SAR processing. This phase error is used to determine the snow depth or the snow water equivalent.

If there is no snow on the earth's surface, the phase of the radar signal along the azimuth direction for a point target captured by the SAR radar equipment is described in a manner known per se as follows:

$${Φ}_{a} ( {t}_{a z} ) \approx {τ}_{0 , a} \cdot {f}_{0} \cdot 2 \cdot π + {f}_{R , a} \cdot π \cdot {t}_{a z}^{2} \qquad ( 4 )$$

t_{az} denotes the azimuth time (i.e. the relative displacement of the radar equipment with respect to the point target in the azimuth direction), fₒ is the center frequency of the radar signal, τ₀ is the propagation time of the radar pulse from the radar equipment to the point target and back for the shortest distance between the radar equipment and the point target, i.e. at the azimuth time t_{az}=0. This corresponds to 2R₀ in FIG. 1. Furthermore, f_{R,α} denotes the Doppler rate, i.e. the temporal rate of change or temporal derivative of the Doppler frequency. The index α denotes the case in which there is no snow on the earth's surface and the radar pulses propagate only through the air.

The Doppler rate is approximately given by the following equation:

$${f}_{R , a} \approx \frac{4 \cdot {v}_{e}^{2}}{{λ}_{0} \cdot {c}_{0} \cdot {τ}_{0 , a}} \qquad ( 5 )$$

υₑ is the effective speed between the radar equipment and the point target, λ₀ is the wavelength of the radar pulses in air and c₀ is the propagation speed of the radar pulses in air (i.e. the speed of light). As defined above, τ_{0,α} is the propagation time of a radar pulse for the shortest distance between the radar equipment and the point target in the case that there is no snow on the point target.

For a point target covered with snow and for the same propagation time τ₀=τ_{0,α} of the radar pulse, the Doppler rate f_{R,s} as a function of the Doppler rate for the case without snow is as follows:

$${f}_{R , s} \approx {f}_{R , a} \cdot ζ \qquad ( 6 )$$

The term ζ takes into account the refraction at the snow surface and the reduced propagation speed in the snow. The term ζ depends on the quantities defined above and in particular the snow depth Zₛ as follows:

$$ζ = \frac{( h + {Z}_{s} \cdot \sqrt{{ε}_{s}} \frac{cos {θ}_{i}}{cos {θ}_{r}} ) \cdot \sqrt{{ε}_{s}}}{h \cdot \sqrt{{ε}_{s}} + {Z}_{s} \frac{cos {θ}_{i}}{cos {θ}_{r}}} \qquad ( 7 )$$

Equations (6) and (7) result from a geometric derivation of the change in the Doppler rate f_{R,s} compared to the Doppler rate f_{R,α} for the case without snow. Viewed from the point target, the Doppler rate describes the rate of change of the Doppler frequency under which the point target is observed. A point target under a snow cover leads to a faster change in the Doppler frequency as the azimuth sampling is compressed. This results in a higher Doppler rate.

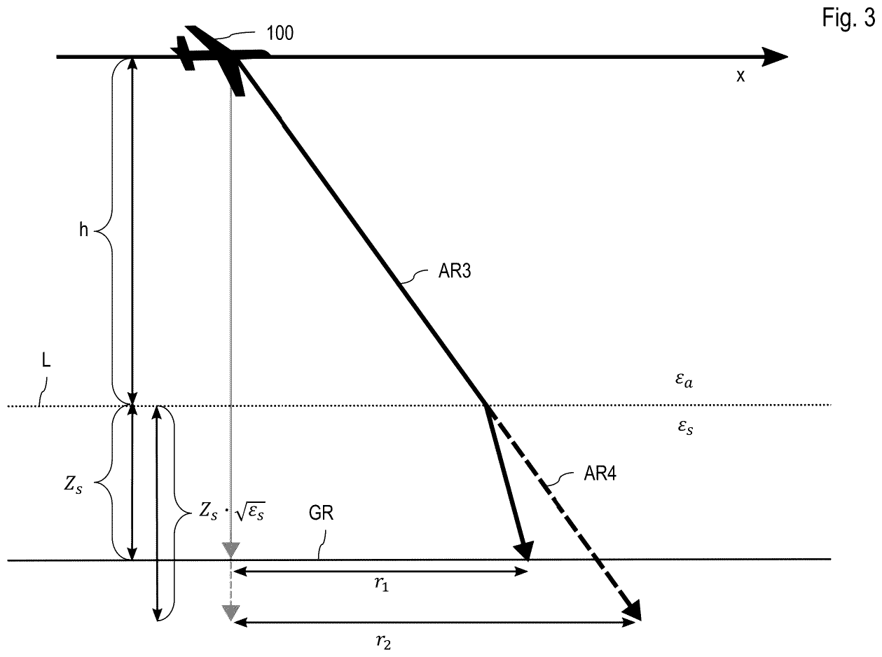

The higher Doppler rate can be derived by quantifying the compressed azimuth sampling. This is illustrated in FIG. 3. This figure shows a schematic representation of the emission of a radar pulse in the case of snow on the earth's surface, viewed in the opposite direction to the ground range direction y. By analogy with FIG. 2, Zₛ denotes the snow depth, L is the snow surface, GR is the earth's surface and h corresponds to the flight altitude of the radar equipment 100 above the snow surface L. The solid arrow AR3 denotes the radar radiation deflected by the snow, i.e. the case εₛ>ε_{α}. In contrast, the arrow AR4 represents the case where there is no snow on the earth's surface (i.e. εₛ=ε_{α}). In the case without snow, the size Zₛ scales with the factor \sqrt{εₛ} due to the higher propagation speed resulting from the absence of snow. For the radar radiation shown in FIG. 3, this results in an azimuth position r₁ for the case with snow, whereas for the case without snow the azimuth position for the radar radiation under consideration is r₂. This results in a compression of the azimuth positions for the case with snow. The ratio

$$\frac{{r}_{2}}{{r}_{1}}$$

describes the ratio of the Doppler rate for a point target with snow cover to the Doppler rate of the point target without snow, i.e. the following applies:

$${f}_{R , s} = {f}_{R , a} \cdot \frac{{r}_{2}}{{r}_{1}} = {f}_{R , a} \cdot ζ$$

The above equation (7) results from the geometric derivation of the ratio

$$\frac{{r}_{2}}{{r}_{1}}$$

according to FIG. 3, where θᵢ is the incidence angle and θᵣ is the refraction angle according to FIG. 2. The correctness of equations (6) and (7) was verified by the inventors with the aid of a numerical ray tracing simulation for a snow-covered point target.

Taking equation (4) into account, the following phase error results between the recorded signal and the signal after SAR processing:

$$Δ Φ ( {t}_{a z} ) = π \cdot ( {f}_{R , s} - {f}_{R , a} ) \cdot {t}_{a z}^{2} = π \cdot Δ {f}_{R} \cdot {t}_{a z}^{2} \qquad ( 8 )$$

For a SAR acquisition with a Doppler center frequency f_{DC} (mean Doppler frequency) not equal to zero, the phase error leads to a displacement of the focused image in the azimuth direction (azimuth time), which can be approximated as follows:

$$Δ t \approx {f}_{D C} \cdot \frac{Δ {f}_{R}}{{f}_{R , a}^{2}} = {f}_{D C} \cdot \frac{ζ - 1}{{f}_{R , a}} \qquad ( 9 )$$

Equation (9) is a well-known approximation for a displacement in azimuth direction in a SAR image, which results from a deviation Δf_{R} of the Doppler rate between the filter used for azimuth compression in SAR processing and the acquired signal for a SAR acquisition with the Doppler center frequency f_{DC}≠0 (see also document [2], equation (6)).

The factor ζ is a function of the snow depth Zₛ (see equation (7)) and thus has a direct relationship to the snow water equivalent (see equation (1)). Consequently, the azimuth shift is a direct measure of the snow water equivalent.

According to the invention, the azimuth shift according to equation (9) is used to determine the snow depth and the snow water equivalent, respectively. For this purpose, two SAR images with different Doppler center frequencies are synthesized from one SAR acquisition. The SAR images with different Doppler center frequencies are obtained by processing different parts of the Doppler spectrum of the SAR acquisition.

According to the above equations (9), (7) and (1), the snow depth and snow water equivalent can be obtained from the displacements of two SAR images with different Doppler center frequencies, as explained in more detail below. According to equation (9),

$$Δ {t}_{D C 1} = {f}_{D C 1} \cdot \frac{ζ - 1}{{f}_{R , a}}$$

denotes the azimuth shift for a frequency range with the Doppler frequency f_{DC1} and

$$Δ {t}_{D C 2} = {f}_{D C 2} \cdot \frac{ζ - 1}{{f}_{R , a}}$$

denotes the azimuth shift for a frequency range with the Doppler frequency f_{DC2}. This results in an azimuth shift Δx (in meters) between the SAR images with the two Doppler center frequencies as follows:

$$Δ x = ( {f}_{D C 2} \cdot \frac{ζ - 1}{{f}_{R , a}} - {f}_{D C 1} \cdot \frac{ζ - 1}{{f}_{R , a}} ) \cdot {v}_{e} \qquad ( 10 )$$

f_{R,α} is obtained from equation (5). The following relationship results for the quantity ζ from equation (10) above:

$$ζ = \frac{Δ x \cdot {f}_{R , a}}{( {f}_{D C 2} - {f}_{DC 1} ) \cdot {v}_{e}} + 1 \qquad ( 11 )$$

A dependence of the displacement of the image contents between the SAR images in the frequency ranges with the different Doppler center frequencies on the parameter ζ is thus obtained.

The parameter ζ in turn depends on the snow depth according to equation (7). The following relationship is obtained by rearranging equation (7):

$${Z}_{s} = \frac{\sqrt{{ε}_{s}} \cdot ( h - h \cdot ζ )}{\frac{cos {θ}_{i}}{cos {θ}_{r}} \cdot ( ζ - {ε}_{s} )} \qquad ( 12 )$$

Thus, from the displacement Δx between the SAR images in frequency ranges with different Doppler center frequencies, the value ζ is obtained, from which the snow depth can be obtained using equation (12). The quantities contained in equation (12) in addition to the value ζ are already known with sufficient accuracy or can be determined using Snellius' law of refraction (quantity θᵣ).

Assuming that the density of the snow is constant, the snow water equivalent SWE based on equation (1) above is given as follows:

$$SWE = \frac{{ρ}_{s}}{{ρ}_{w}} \cdot {Z}_{s} \qquad ( 13 )$$

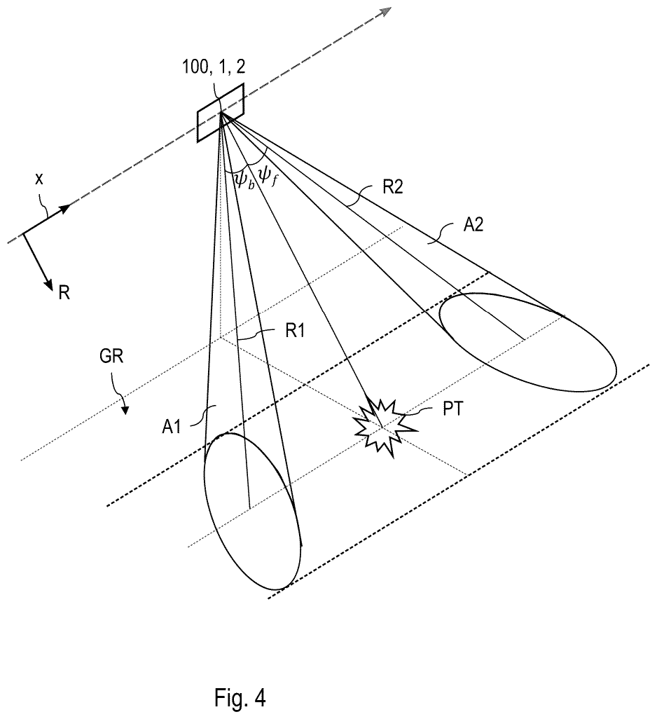

In the following, the invention is explained again with reference to a specific embodiment in which the use of two antennas with different beam directions in the SAR radar equipment achieves a good division of the detected SAR raw data into two frequency ranges with different Doppler center frequencies. FIG. 4 shows a schematic illustration of the structure of this SAR system. Instead of two antennas, a single antenna can also be used, which radiates in two different beam directions.

In analogy to FIG. 1, the radar equipment 100 moves along the azimuth direction x above the earth's surface GR. The point target detected in the overflight is indicated by an asterisk and designated by reference sign PT. The radar equipment 100 contains two antennas 1 and 2, which are not shown separately. Antenna 1 is a combined transmitting and receiving antenna and its associated antenna beam is designated by reference sign A1 in FIG. 4. The main beam direction of the antenna beam, i.e. the radiation direction with the highest energy, is designated for the antenna beam A1 by reference sign R1. In contrast, the antenna beam for antenna 2 is designated by A2 and its main beam direction is designated by reference sign R2. The beam direction R1 of antenna 1 is inclined with a backward squint angle ψ_{b} relative to the plane perpendicular to the azimuth direction. In contrast, the beam direction R2 of antenna 2 is inclined with a forward squint angle of relative to the plane perpendicular to the azimuth direction. In the embodiment described herein, the two squint angles ψₚ and ψ_{f} are equal.

With the arrangement of FIG. 4, two opposite frequency ranges of the Doppler spectrum are simultaneously recorded in the SAR raw data. In a manner known per se, the Doppler center frequency for the antenna 1 with the antenna beam A1 is given as follows:

$${f}_{D C 1} = - \frac{2 {v}_{e}}{λ} \cdot sin {ψ}_{b}$$

Analogously, the Doppler center frequency for antenna 2 with antenna beam A2 is given as follows:

$${f}_{D C 2} = \frac{2 {v}_{e}}{λ} \cdot sin {ψ}_{f}$$

Here, vₑ denotes the azimuth speed of the radar equipment and A corresponds to the wavelength of the radar radiation.

The forward squint ψ_{f} angle of leads to a positive Doppler center frequency, whereas the backward squint angle ψ_{b} corresponds to a negative Doppler center frequency. The magnitudes of the center frequencies increase with larger squint angles, which in turn leads to a larger displacement Δx in azimuth direction, i.e. to a higher sensitivity in the detection of the snow depth or the snow water equivalent.

As mentioned, the two squint angles ψ_{b} and ψ_{f} are chosen to be equal, i.e. f_{DC2}=−f_{DC1}. Consequently, the parameter ζ can be calculated as follows according to equation (11) above:

$$ζ = \frac{Δ x \cdot {f}_{R , a}}{2 \cdot {v}_{e} \cdot {f}_{D C , 2}} + 1$$

From this, the snow depth can then be calculated according to equations (11) and (12) above, as well as the snow water equivalent using equation (13) above.

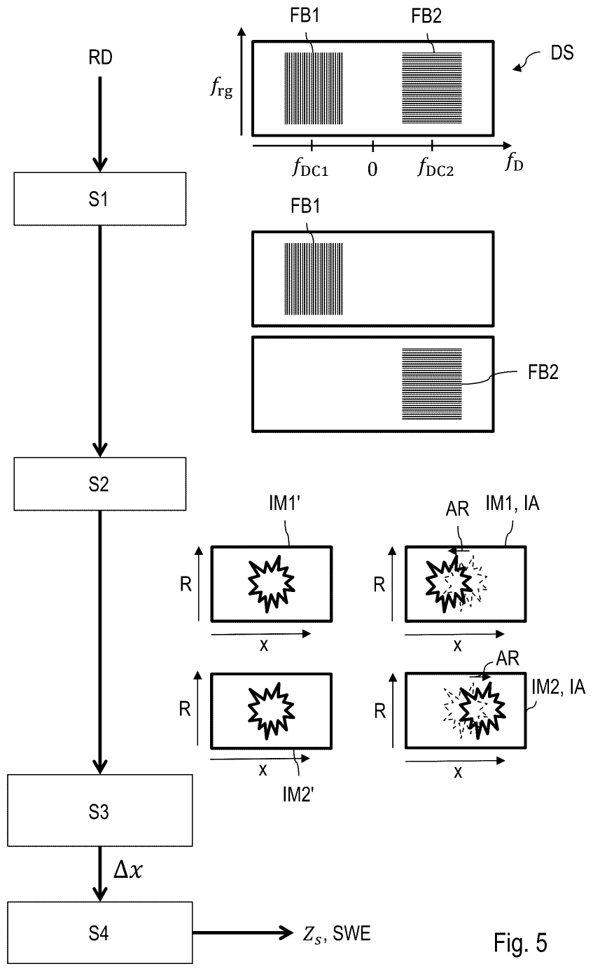

FIG. 5 again illustrates the steps for determining the snow depth and the snow water equivalent based on the arrangement in FIG. 4. First, the radar equipment 100 of FIG. 4 is used to obtain SAR raw data RD using antennas 1 and 2 in a manner known per se. The corresponding Doppler spectrum DS of the raw data RD is shown schematically in a diagram in FIG. 5. The abscissa of the diagram denotes the Doppler frequency f_{D}, whereas the ordinate corresponds to the range frequency f_{rg}. The two squint angles in the forward and backward directions result in two separate frequency ranges FB1 and FB2 in the Doppler spectrum DS. The frequency range FB1 corresponds to the Doppler center frequency f_{DC1} and the frequency range FB2 to the Doppler center frequency f_{DC2}.

In step S1 of FIG. 5, the two frequency ranges FB1 and FB2 are separated from the SAR raw data RD, which is achieved by a Fourier transformation and subsequent bandpass filtering. Then, in step S2, the two frequency ranges FB1 and FB2 are separately subjected to a known SAR processing with range compression and azimuth compression. In the case that there is no snow on the earth's surface, the SAR image IM1′ is obtained for the frequency range FB1 and the SAR image IM2′ for the frequency range FB2. Evidently, the two images are identical.

In contrast, if there is snow on the earth's surface, there is a displacement between the two images or their image contents in azimuth direction. In FIG. 1, IM1 is the SAR image for the frequency range FB1 in the case of a snow layer and IM2 is the image for the frequency range FB2 in the case of a snow layer. In the embodiment described herein, the image IM1 as whole corresponds to an image area IA. Analogously, the image IM2 as whole corresponds to an image area IA. Usually, the images are divided into smaller image areas, i.e. the two images contain a plurality of corresponding image areas IA. Corresponding displacements of the image contents are then determined separately for the individual image areas.

As can be seen, in the case of snow cover, the image content of image IM1 (i.e. the point target PT from FIG. 4) is displaced in azimuth direction oppositely to the image content of image IM2. This is indicated by corresponding arrows AR, which represent the displacement of the point target compared to the point target without snow (shown dashed). The greater the snow depth, the greater the opposite displacement between images IM1 and IM2. The displacement Δx between the images IM1 and IM2, which corresponds to the quantity in equation (10), is determined by comparing these images in step S3. Then, in step S4, the snow depth Zₛ is determined from the displacement Δx using the above equations (11) and (12) and the snow water equivalent SWE is determined using the above equation (13).

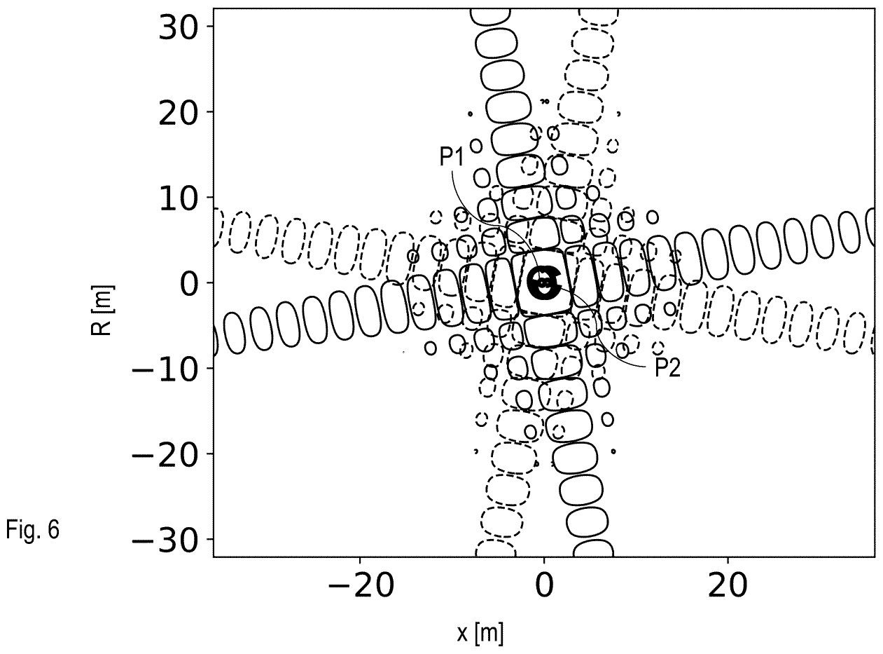

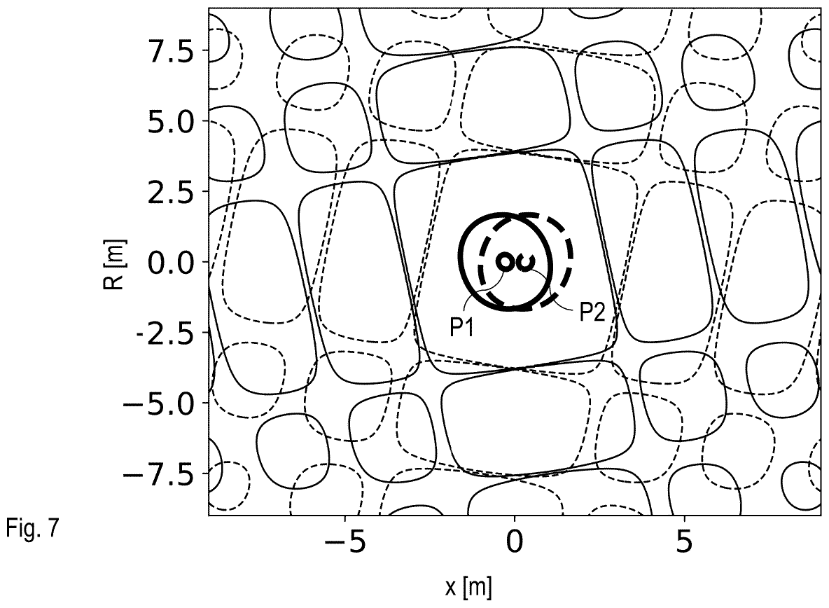

The method according to the invention was tested by the inventors both on the basis of simulated SAR raw data and on the basis of real SAR raw data. FIG. 6 to FIG. 9 show results from the simulation of SAR raw data for a point target on the earth's surface and a snow water equivalent of 1.0 m. FIG. 6 and FIG. 7 concern simulated SAR images with squint angles ψ_{f} and ψ_{b} of +10° and −10°, whereby the SAR image for the squint angle of −10° is shown with solid contour lines and the SAR image for the squint angle of +10° is shown with dashed contour lines in FIG. 6 and FIG. 7. The position of the point target for the squint angle at −10° is labeled P1 in FIG. 6 and FIG. 7, whereas the position of the point target for the squint angle at +10° is labeled P2 in FIG. 6 and FIG. 7. FIG. 7 shows an enlargement of the images from FIG. 6 at the corresponding positions P1, P2 of the illustration from FIG. 6. As can be seen, there is indeed a displacement in the azimuth direction between the point targets.

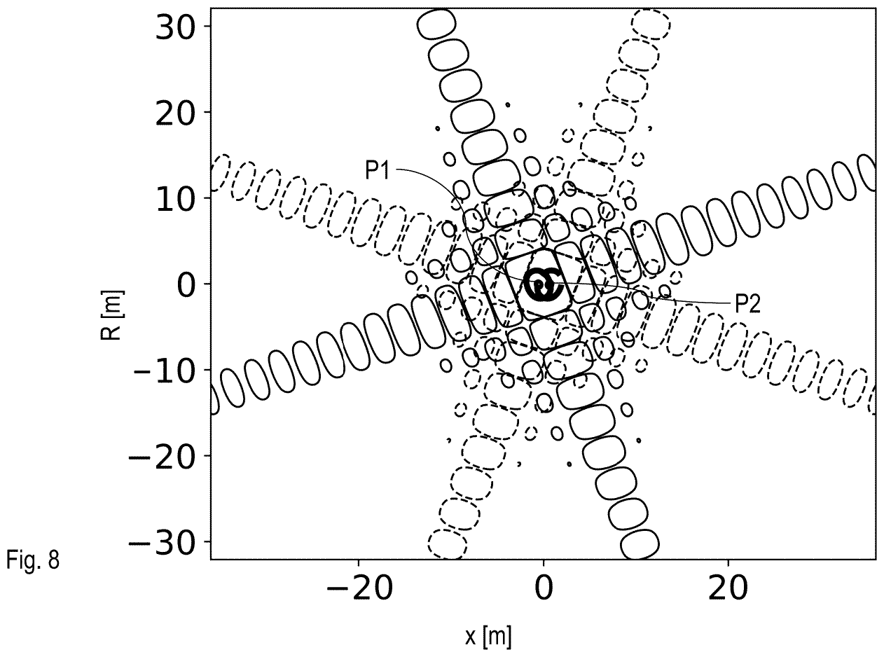

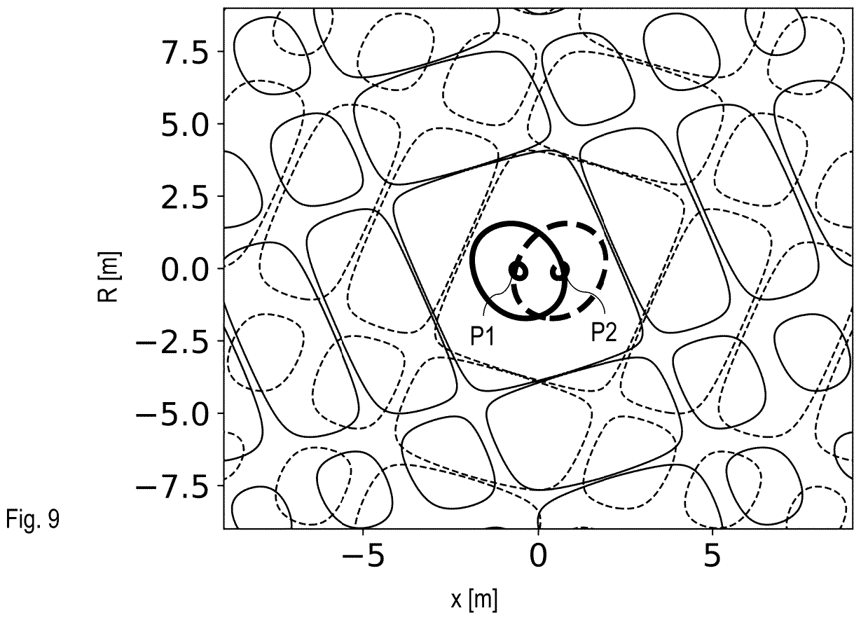

FIG. 8 and FIG. 9 again show the analogous representations to FIG. 6 and FIG. 7, but assuming larger squint angles of +20° and −20°. As can be seen, the displacement between the detected point targets also increases as the squint angle increases.

The inventors have further carried out an analysis of the accuracy of determining the snow water equivalent for the simulation just described. For this purpose, in a Monte Carlo simulation, several variants of normally distributed noise for different SNR levels (SNR=signal-to-noise ratio) from 0 dB to 25 dB were added to each of the SAR images taken with the different squint angles. For each SNR level, 1000 variants of noise were used. The displacement between the images was then measured using a cross-correlation and the snow water equivalent SWE was determined from this.

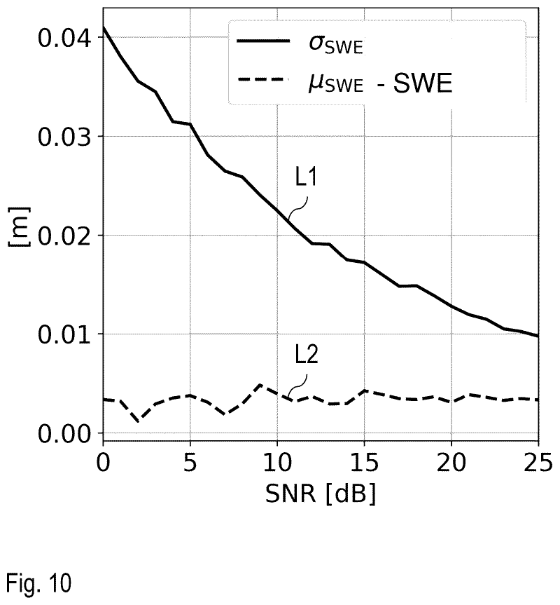

FIG. 10 shows a diagram that illustrates the result of the Monte Carlo simulation for the squint angle of ±10°. The solid line L1 represents the standard deviation σ_{SWE} as a function of the signal-to-noise ratio SNR, whereas the dashed line L2 represents the mean value μ_{SWE} of the snow water equivalent minus the actual snow water equivalent SWE (i.e. 1 m). As can be seen from FIG. 10, the standard deviation is very small compared to the snow water equivalent of 1 m. The mean value of the snow water equivalent also deviates only slightly from the actual value of 1 m.

As already mentioned, the method according to the invention was also tested using real SAR data from a natural environment with meadows, forests and urban areas. For this purpose, phase errors corresponding to a certain SWE value were synthetically inserted into the real SAR data. For the natural scene, corresponding SWE values were determined for image blocks with an extension of 80 m in range and 110 m in azimuth. The measurement is not based on the displacement measurement of point targets, but on the displacement measurement of extended natural scenes with contrast. The snow water equivalent could also be determined with high accuracy for real SAR data.

The embodiments of the method according to the invention described above have a number of advantages. In particular, the absolute snow depth and the snow water equivalent can be determined with high accuracy from SAR raw data by means of a single overflight. In contrast, currently known methods can only determine differences in snow depth using interferometric measurements based on SAR acquisitions from several overflights. In addition, the method according to the invention no longer has the disadvantage of interferometric measurements, in which temporal decorrelation effects can occur between two SAR acquisitions and which are subject to a 2π-phase ambiguity.

### LIST OF REFERENCES

[1] T. Guneriussen, K. A. Høgda, H. Johnsen, and I. Lauknes, “InSAR for estimation of changes in snow water equivalent of dry snow,” IEEE Trans. Geosci. Remote Sens., vol. 39, no. 10, pages 2101-218 October 2001.
[2] M. Rodriguez-Cassola et al, “Doppler-Related Distortions in TOPS SAR Images,” in IEEE Transactions on Geoscience and Remote Sensing, vol. 53, no. 1, pages 25-35, January 2015

1. A method for computer-implemented processing of SAR raw data (RD) originating from a radar equipment flying over the earth's surface (GR) in an azimuth direction (x), wherein the SAR raw data (RD) represent radar echoes from radar pulses (RP) during a single overflight over an area of the earth's surface (GR), wherein the radar pulses (RP) are or were transmitted by the radar equipment and the radar echoes are or were received by the radar equipment as radar pulses reflected at the earth's surface (GR), wherein the SAR raw data (RD) comprise a plurality of data samples containing a Doppler spectrum (DS), wherein a respective data sample is associated with an azimuth position along the azimuth direction (x) and a range position along a range direction (R), the range direction (R) being perpendicular to the azimuth direction, characterized in that the SAR raw data (RD) comprises a plurality of data samples containing a Doppler spectrum (DS), the respective data samples being associated with an azimuth position along the azimuth direction (x) and a range position along a range direction (R), wherein the range direction (R) being perpendicular to the azimuth direction (x), wherein
a) a first frequency range (FB1) of the Doppler spectrum (DS) with a first Doppler center frequency (f_{DC1}) and a second frequency range (FB2) of the Doppler spectrum (DS) with a second Doppler center frequency (f_{DC2}) are extracted from the SAR raw data (RD), wherein the first frequency range (FB1) is disjoint from the second frequency range (FB2);
b) a first SAR image (IM1) is determined from the first frequency range (FB1) and a second SAR image (IM2) is determined from the second frequency range (FB2);
c) a displacement value (Δx) is determined for a respective image area (IA) of a number of image areas (IA) in the first SAR image (IM1), the displacement value (Δx) indicating by how much the image content in the respective image area (IA) from the first SAR image (IM1) is displaced in the azimuth direction (x) with respect to the same image content in a corresponding image area (IA) from the second SAR image (IM2), wherein the respective image area (IA) and the corresponding image area (IA) represent the same surface area with respect to the azimuth direction (x) and the range direction (R);
d) a snow depth (Zₛ) in the respective image area (IA) is determined from the displacement value (Δx).

2. The method according to claim 1, wherein in step d) a value dependent on the snow depth is determined from the snow depth (Zₛ), which value is optionally the snow water equivalent (SWE).

3. The method according to claim 1, wherein the snow depth (Zₛ) is determined in step d) as follows:
$${Z}_{s} = \frac{\sqrt{{ε}_{s}} \cdot ( h - h \cdot ζ )}{\frac{cos {θ}_{i}}{cos {θ}_{r}} \cdot ( ζ - {ε}_{s} )}$$
wherein Zₛ is the snow depth;
wherein εₛ is the real part of the relative dielectric permittivity of snow;
wherein h is the flight altitude of the radar equipment above the snow surface;
wherein θᵢ is the incidence angle of the radar pulses (RP) in the respective image area (IA);
wherein θᵣ is the refraction angle of the radar pulses (RP) in the respective image area (IA) on the snow surface;
wherein
$$ζ = \frac{Δ x \cdot {f}_{R , a}}{( {f}_{D C 2} - {f}_{DC 1} ) \cdot {v}_{e}} + 1$$
wherein Δx is the displacement value in meters in the azimuth direction (x);
wherein vₑ is the azimuth speed of the radar equipment;
wherein f_{DC1} is the first Doppler center frequency (f_{DC1});
wherein f_{DC2} is the second Doppler center frequency (f_{DC2});
wherein f_{R,α} is the Doppler rate without snow in the respective image area (IA).

4. The method according to claim 1, wherein the SAR raw data (RD) originate from a radar equipment comprising an antenna equipment which generates an antenna beam for transmitting and receiving radar radiation in a first beam direction (R1) and an antenna beam for transmitting and receiving radar radiation in a second beam direction (R2), wherein the first beam direction (R1) is inclined at a first inclination angle (ψ_{b}) relative to the plane extending perpendicular to the azimuth direction (x) and wherein the second beam direction (R2) is inclined at a second inclination angle (ψ_{f}) relative to the plane extending perpendicular to the azimuth direction (x), wherein the first beam direction (R1) and the second beam direction (R2) differ from each other.

5. The method according to claim 4, wherein the first inclination angle (ψ_{b}) is a backward angle, so that the first beam direction (R1) lies behind the radar equipment with respect to the movement of the radar equipment in the azimuth direction (x), and the second inclination angle (ψ_{f}) is a forward angle, so that the second beam direction (R2) lies in front of the radar equipment with respect to the movement of the radar equipment in the azimuth direction (x).

6. The method according to claim 5, wherein the forward angle is between 2° and 40°, between 5° and 25° or between 15° and 25° and/or the backward angle is between 2° and 40°, between 5° and 25° between 15° and 25°.

7. The method according to claim 5, wherein the forward angle is as large as the backward angle.

8. An apparatus for computer-implemented processing of SAR raw data (RD) originating from a radar equipment flying over the earth's surface (GR) in an azimuth direction (x), wherein the SAR raw data (RD) represent radar echoes from radar pulses (RP) during a single overflight over an area of the earth's surface (GR), wherein the radar pulses (RP) are or were transmitted by the radar equipment and the radar echoes are or were received by the radar equipment as radar pulses reflected at the earth's surface (GR), wherein the SAR raw data (RD) comprise a plurality of data samples containing a Doppler spectrum (DS), wherein a respective data sample is associated with an azimuth position along the azimuth direction (x) and a range position along a range direction (R), the range direction (R) being perpendicular to the azimuth direction, wherein the apparatus is configured to perform a method in which:
a) a first frequency range (FB1) of the Doppler spectrum (DS) with a first Doppler center frequency (f_{DC1}) and a second frequency range (FB2) of the Doppler spectrum (DS) with a second Doppler center frequency (f_{DC2}) are extracted from the SAR raw data (RD), wherein the first frequency range (FB1) is disjoint from the second frequency range (FB2);
b) a first SAR image (IM1) is determined from the first frequency range (FB1) and a second SAR image (IM2) is determined from the second frequency range (FB2);
c) a displacement value (Δx) is determined for a respective image area (IA) of a number of image areas (IA) in the first SAR image (IM1), the displacement value indicating by how much the image content in the respective image area (IA) from the first SAR image (IM1) is displaced in the azimuth direction (x) with respect to the same image content in a corresponding image area (IA) from the second SAR image (IM2), wherein the respective image area (IA) and the corresponding image area (IA) represent the same surface area with respect to the azimuth direction (x) and the range direction (R);
d) a snow depth (Zₛ) in the respective image area (IA) is determined from the displacement value (Δx).

9. (canceled)

10. A computer program product comprising a program code stored on a machine-readable medium for carrying out a method according to claim 1, when the program code is executed on a computer.

11. A computer program comprising a program code for carrying out a method according to claim 1, when the program code is executed on a computer.

12. The apparatus according to claim 8, wherein in step d) a value dependent on the snow depth is determined from the snow depth (Zₛ), which value is optionally the snow water equivalent (SWE).

13. The apparatus according to claim 8, wherein the snow depth (Zₛ) is determined in step d) as follows:
$${Z}_{s} = \frac{\sqrt{{ε}_{s}} \cdot ( h - h \cdot ζ )}{\frac{cos {θ}_{i}}{cos {θ}_{r}} \cdot ( ζ - {ε}_{s} )}$$
wherein Zₛ is the snow depth;
wherein εₛ is the real part of the relative dielectric permittivity of snow;
wherein h is the flight altitude of the radar equipment above the snow surface;
wherein θᵣ is the incidence angle of the radar pulses (RP) in the respective image area (IA);
wherein er is the refraction angle of the radar pulses (RP) in the respective image area (IA) on the snow surface;
$$ζ = \frac{Δ x \cdot {f}_{R , a}}{( {f}_{D C 2} - {f}_{DC 1} ) \cdot {v}_{e}} + 1$$
wherein Δx is the displacement value in meters in the azimuth direction (x);
wherein vₑ is the azimuth speed of the radar equipment;
wherein f_{DC1} is the first Doppler center frequency (f_{DC1});
wherein f_{DC2} is the second Doppler center frequency (f_{DC2});
wherein f_{R,α} is the Doppler rate without snow in the respective image area (IA).

14. The apparatus according to claim 8, wherein the SAR raw data (RD) originate from a radar equipment comprising an antenna equipment which generates an antenna beam for transmitting and receiving radar radiation in a first beam direction (R1) and an antenna beam for transmitting and receiving radar radiation in a second beam direction (R2), wherein the first beam direction (R1) is inclined at a first inclination angle (ψ_{b}) relative to the plane extending perpendicular to the azimuth direction (x) and wherein the second beam direction (R2) is inclined at a second inclination angle (ψ_{f}) relative to the plane extending perpendicular to the azimuth direction (x), wherein the first beam direction (R1) and the second beam direction (R2) differ from each other.

15. The apparatus according to claim 14, wherein the first inclination angle (ψ_{b}) is a backward angle, so that the first beam direction (R1) lies behind the radar equipment with respect to the movement of the radar equipment in the azimuth direction (x), and the second inclination angle (ψ_{f}) is a forward angle, so that the second beam direction (R2) lies in front of the radar equipment with respect to the movement of the radar equipment in the azimuth direction (x).

16. The apparatus according to claim 15, wherein the forward angle is between 2° and 40°, between 5° and 25° or between 15° and 25° and/or the backward angle is between 2° and 40°, between 5° and 25° or between 15° and 25°.

17. The apparatus according to claim 15, wherein the forward angle is as large as the backward angle.
